(19) United States
(12) Patent Application Publication
(10) Pub. No.: US 2010/0164797 A1
(43) Pub. Date: Jul. 1, 2010

(54) METHOD FOR TRACKING SATELLITES WITH MULTIPLE-FREQUENCIES

(75) Inventor: Hung Sheng Chen, Banqiao City (TW)

Correspondence Address: STEVENS & SHOWALTER LLP, 7019 CORPORATE WAY, DAYTON, OH, 45459-4238, US

(73) Assignee: ALTEK CORPORATION, Hsinchu (TW)

(21) Appl. No.: 12/436,826

(22) Filed: May 7, 2009

(30) Foreign Application Priority Data
Dec. 31, 2008 (TW) 097151808

(51) Int. Cl. G01S 1/00

(52) U.S. Cl. 342/357.12

(57) ABSTRACT

A method for tracking satellite with multiple-frequencies includes setting a first tracking frequency, tracking a satellite with the first tracking frequency to obtain a first tracking result at a first time point, estimating a second tracking frequency at a second time point according to the first tracking result at the first time point, adjusting the second tracking frequency in a predetermined range to obtain preparatory frequencies, tracking the satellite with the preparatory frequencies to obtain second tracking results, and reviewing strength of received signal of each second tracking result to select the strongest one, and setting the preparatory frequency used to obtain the strongest received signal as a determined tracking frequency to be used to form the communication between a global positioning system (GPS) device and the satellite, repeating the above steps, thereby maintaining the communication with a best tracking frequency between the GPS device and the satellite.

### CROSS-REFERENCE TO RELATED APPLICATIONS

This non-provisional application claims priority under 35 U.S.C. § 119(a) on Patent Application No(s). 097151808 filed in Taiwan, R.O.C. on Dec. 31, 2008 the entire contents of which are hereby incorporated by reference.

### BACKGROUND OF THE INVENTION

1. Field of Invention

The present invention relates to a method for tracking satellites, and more particularly to a method for tracking satellites with multiple-frequencies.

2. Related Art

A global position system (GPS) is based on a basic principle of triangulation location of satellites. From the positions of the satellites, the distances between the satellites and the GPS device are measured, thereby obtaining the three-dimensional coordinate value of the position of the GPS device. When the GPS device receives one satellite signal, the GPS device can convert the signal into the distance between its position and the satellite by an internal microprocessor. When the GPS device receives two satellite signals, the GPS device can calculate a plane coordinate information. When the GPS device receives a third satellite signal, the GPS device can calculate the coordinate information of its position. Normal GPS devices utilize more than four received satellite signals to determine the position and the height of the GPS device. And if five to six satellite signals or more are received by the GPS device continuously, a more precise location information may be obtained.

Now considering 32 launched satellites in operation, they are uniformly distributed in six orbit planes. The orbit inclination angle is about 55°. The height of the satellites is about 20,183 kilometers. The period of the satellites is 11 hours and 58 minutes. That is, each satellite orbits the earth twice along the same path. Such a design ensures that the user on the earth can see more than four satellites at any place and any time.

When the GPS device intends to know its current position, it may compare the time data sent from the satellites with one another. And the GPS device may determine that how far it is from each satellite according to the differences of these times, thereby obtaining the current position.

A satellite signal received by the GPS device contains a pseudo random number and an ephemeris data. The pseudo random number is used for identifying the data being transferred by that satellite. The ephemeris data tells the GPS device the positions where each satellite should be in a whole day. Therefore, the ephemeris data transferred by each satellite presents the orbit data of the satellite. The ephemeris data includes an ephemeris table which is used for recording the data continuously transferred by each satellite, such as the state of the satellite, the current data and time, and the like.

The GPS device performs a satellite tracking program with a predetermined tracking frequency when communicating with a satellite, and estimates the tracking frequency intended to be used next time according to the previous tracking result after such a tracking result is obtained. However, the tracking result will be interfered by noises, which results in that a large error may occur in the tracking frequency at the next time point, and thus an error happens in the received ephemeris data. Therefore, the method for tracking with a single frequency has the problems described above.

### SUMMARY OF THE INVENTION

In view of the above problems, the present invention provides a method for tracking satellite with multiple-frequencies, in which a global positioning system (GPS) device performs the same tracking actions with multiple-frequencies around an expected tracking frequency, and select the tracking frequency used to obtain the strongest received signal to keep on tracking, such that the capability of tracking satellite of the GPS device is enhanced, thereby reducing the occurrence of errors in the ephemeris data.

Therefore, the present invention provides a method for tracking satellite with multiple-frequencies, in which a GPS device communicates with a satellite with multiple tracking frequencies, and determines a preferred tracking frequency to be used to form the communication between the GPS device and the satellite according to the result of the communication, i.e. the tracking results corresponding to the multiple tracking frequencies. The method includes setting a first tracking frequency, tracking a satellite with the first tracking frequency to obtain a first tracking result at a first time point, estimating a second tracking frequency to be used at a second time point according to the first tracking result at the first time point, adjusting the second tracking frequency in a predetermined range to obtain preparatory frequencies, tracking the satellite with the preparatory frequencies to obtain corresponding second tracking results, reviewing strength of received signal of each second tracking results to select the strongest one, setting the preparatory frequency used to obtain the strongest received signal as a determined tracking frequency to be used to form the communication between the GPS device and the satellite, and repeating the above steps to continuously obtain the determined tracking frequency, thereby maintaining the communication with a best tracking frequency between the GPS device and the satellite.

In the method for tracking satellite with multiple-frequencies according to the present invention, the same tracking actions are performed with multiple tracking frequencies around the expected tracking frequency, and the tracking frequency corresponding to the strongest received signal is selected to keep on tracking, such that the capability of tracking the satellite of the GPS device is enhanced, thereby reducing the occurrence of errors in the ephemeris data.

### BRIEF DESCRIPTION OF THE DRAWINGS

The present invention will become more fully understood from the detailed description given herein below for illustration only, and thus are not limitative of the present invention, and wherein:

FIG. 1 is a flowchart of steps of a method according to the present invention.

### DETAILED DESCRIPTION OF THE INVENTION

The method for tracking satellite with multiple-frequencies according to the present invention is applicable to an electronic device with a global positioning system (GPS). That is, the method according to the present invention can be applied in a GPS device, such that the GPS device can communicate with a satellite with a best tracking frequency.

The method according to the present invention can be implemented through a software or firmware program. The software or firmware program can be built into a storage device of an electronic device. The processor of the electronic device executes the built-in software or firmware program in connection with satellite positioning function, so as to enable the electronic device to realize the method for tracking satellites with multiple-frequencies according to the present invention. The electronic device may be, but not limited to, a computer with the function of satellite positioning, a mobile phone with the function of satellite positioning, or a personal digital assistant (PDA) with the function of satellite positioning, etc.

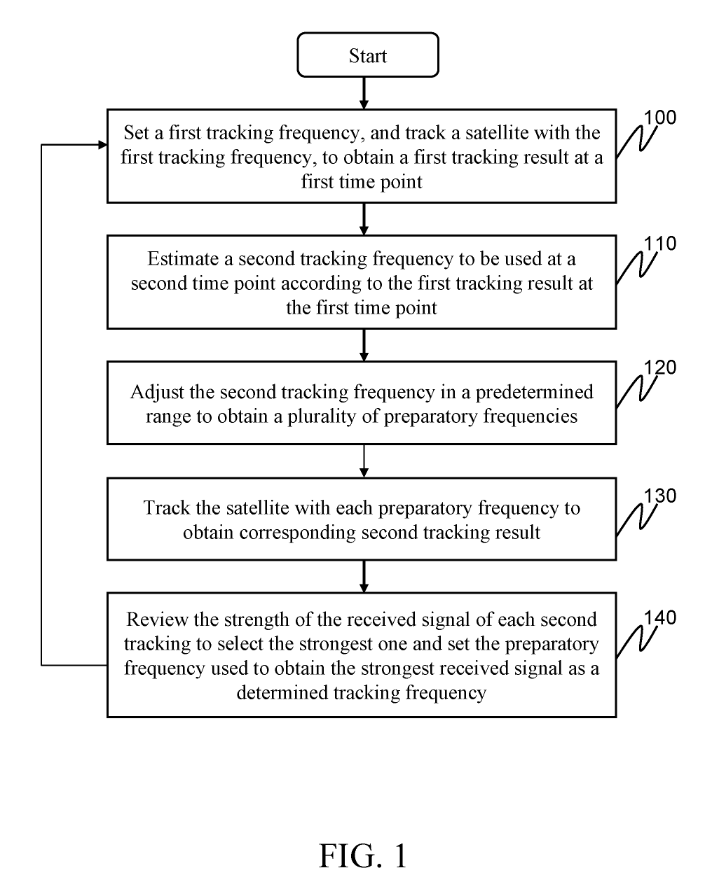

Referring to FIG. 1, in application of the method for tracking satellite with multiple-frequencies according to the present invention, the GPS device can communicate with the satellite with multiple tracking frequencies, and a preferred tracking frequency to be used to form the communication between the GPS device and the satellite is determined according to the results of the communication, i.e. the tracking results corresponding to the multiple tracking frequencies. The method includes the following steps.

First, a first tracking frequency is set (Step 100). Then, a satellite tracking program is executed with the first tracking frequency, to track the satellite with the first tracking frequency and then to obtain a tracking result (called a first tracking result in the following) at a first time point (Step 100). The first tracking frequency may be set by a reference clock oscillator and a frequency synthesizer. The first tracking frequency may be, for example, 35 MHz. The reference clock oscillator can provide the time and frequency reference required by the GPS device, and can provide the reference to the frequency synthesizer to form a local oscillation and the clock of coded carrier tracking. The frequency synthesizer is mainly used for generating a signal with the frequency required during signal receiving and processing (e.g., local oscillation frequency, sampling frequency, and time reference).

The satellite tracking program may comprise retrieving a satellite signal of the satellite, tracking a satellite carrier of the satellite, and tracking a satellite phase of the satellite. The tracking result may comprise virtual distance between the GPS device and the satellite, carrier phase of the satellite signal, Doppler shift of the satellite signal, and quality of the received signal, such as the signal to noise ratio (SNR).

A second tracking frequency to be used at a second time point is estimated according to the first tracking result at the first time point (Step 110). The second tracking frequency to be used at the second time point is estimated according to the parameters obtained from the first tracking result. The second tracking frequency may be, for example, 33 MHz. The way of estimating the second tracking frequency can include receiving a plurality of data from a satellite continuously, calculating a plurality of phase differences of the plurality of received data, calculating a phase difference average of the plurality of calculated phase differences, calculating a frequency difference based on the calculated phase difference average and a frequency fixed parameter, and calculating the second tracking frequency based on the calculated frequency difference and the tracking frequency used to receive the last data of the plurality of received data.

Next, the second tracking frequency is adjusted in a predetermined range to obtain a plurality of frequency values to be selected, i.e. preparatory frequencies (Step 120). The predetermined range comprises any frequency adjustment value between −5 Hz and +5 Hz. In other words, the second tracking frequency is adjusted to obtain multiple preparatory frequencies which are the frequencies between a value obtained by subtracting 5 Hz from the second tracking frequency and 5 Hz and a value obtained by adding the second tracking frequency and 5 Hz. For example, if it is assumed that the second tracking frequency is 33 MHz, the preparatory frequencies include any frequencies between 33.000005 Mhz and 32.999995 Mhz.

The satellite tracking program for the satellite is executed with the preparatory frequencies to track the satellite with the preparatory frequencies, and then a plurality of tracking results (called second tracking results in the following) corresponding to a plurality of time points respectively is obtained (Step 130). Similarly, the satellite tracking program may comprise retrieving a satellite signal of the satellite and tracking satellite carrier and phase of the satellite. The second tracking result may comprise the virtual distance between the GPS device and the satellite, carrier phase and Doppler shift of the satellite signal, and the quality of the received signal, such as the SNR. The execution of the satellite tracking program in Step 130 may use 10 different preparatory frequencies to do testing, such as 33.000005 Mhz, 33.0000010 Mhz, 33.0000015 Mhz, 33.0000020 Mhz, 33.0000025 Mhz, 32.999995 Mhz, 32.999990 Mhz, 32.9999985 Mhz, 32.9999980 Mhz, and 32.9999975 Mhz.

The second tracking results are compared with one another to review strength of received signal of each second tracking result, so as to select the strongest received signal from the second tracking results. Then, the preparatory frequency used to obtain the strongest received signal is set as a determined tracking frequency. The determined tracking frequency can be used to form the communication between the GPS device and the satellite. The Step 100 to Step 140 above are repeated to continuously obtain determined tracking frequencies, thereby maintaining the communication with a best tracking frequency between the GPS device and the satellite (Step 140). Different preparatory frequencies may be corresponding to different tracking results, and the strength of the received signal corresponding to the tracking results are also different. Therefore, through comparing the tracking results with one another (e.g., determined by the quantity of carriers and codes), the preparatory frequency used to obtain the strongest one of the received signals of the tracking results is set as the determined tracking frequency for forming the communication between the GPS device and the satellite, thereby maintaining the communication with a best tracking frequency between the GPS device and the satellite. The range of the strength of the received signals may be, for example, in an order from strong to weak, −120 dBm (strong), −124 dBm, −128 dBm, −132 dBm, and −136 dBm (weak).

In addition, in the present invention, the second tracking frequency may also be set according to the trend of the strength of the received signals presented by multiple tracking results. For example, after the tracking program is executed with 33.000005 Mhz and 32.999995 Mhz respectively, if the strength of the received signal corresponding to 33.000005 Mhz is found to be preferred, when adjusting the frequency for the next time, the frequency above 33.000005 Mhz are taken to do testing, such as 33.000010 Mhz or 33.000015 Mhz. As such, a preferred tracking frequency may be found more quickly.

In view of the above, in the method for tracking satellite with multiple-frequencies according to the present invention, the same tracking actions are preformed with multiple tracking frequencies around the expected tracking frequency, and the tracking frequency corresponding to the strongest received signal is selected to keep on tracking, such that the capability of tracking the satellite of the GPS device is enhanced, thereby reducing the occurrence of errors in the ephemeris data.

What is claimed is:

1. A method for tracking satellite with multiple-frequencies, applicable to a global positioning system (GPS) device for communicating with a satellite, the method comprising:
setting a first tracking frequency;
tracking the satellite with the first tracking frequency to obtain a first tracking result at a first time point;
estimating a second tracking frequency to be used at a second time point according to the first tracking result at the first time point;
adjusting the second tracking frequency in a predetermined range to obtain a plurality of preparatory frequencies;
tracking the satellite with the preparatory frequencies to obtain a plurality of second tracking results respectively; and
reviewing strength of received signal of each of the second tracking results to select the strongest one of the received signals of the second tracking results;
setting the preparatory frequency used to obtain the strongest received signal as a determined tracking frequency to be used to form the communication between the GPS device and the satellite;
repeating the above steps to continuously obtain the determined tracking frequency, thereby maintaining the communication with a best tracking frequency between the GPS device and the satellite.

2. The method for tracking satellite with multiple-frequencies according to claim 1, wherein the step of tracking the satellite comprises retrieving a satellite signal of the satellite, tracking a satellite carrier of the satellite, and tracking a satellite phase of the satellite.

3. The method for tracking satellite with multiple-frequencies according to claim 1, wherein the first tracking result comprises virtual distance, carrier phase and Doppler shift, and quality of the received signal.

4. The method for tracking satellite with multiple-frequencies according to claim 1, wherein each of the second tracking results comprises virtual distance, carrier phase and Doppler shift, and quality of the received signal.

5. The method for tracking satellite with multiple-frequencies according to claim 1, wherein the predetermined range comprises any frequency adjustment value between −5 Hz and +5 Hz.

6. The method for tracking satellite with multiple-frequencies according to claim 1, wherein the preparatory frequencies comprise the second tracking frequency.

7. The method for tracking satellite with multiple-frequencies according to claim 1, wherein the step of estimating a second tracking frequency to be used at a second time point according to the first tracking result at the first time point comprises:
receiving a plurality of data from the satellite continuously;
calculating a plurality of phase differences of the plurality of received data;
calculating a phase difference average of the plurality of calculated phase differences;
calculating a frequency difference based on the calculated phase difference average and a frequency fixed parameter; and
calculating the second tracking frequency based on the calculated frequency difference and tracking frequency used to receive the last data of the plurality of received data.
